(19) United States
(12) Patent Application Publication
(10) Pub. No.: US 2009/0172467 A1
(43) Pub. Date: Jul. 2, 2009

(54) INFORMATION PROCESSING APPARATUS

(75) Inventor: Katsuhiko ARAKI, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/268,762

(22) Filed: Nov. 11, 2008

(30) Foreign Application Priority Data
Dec. 26, 2007 (JP) 2007334832

(51) Int. Cl. G06F 11/08

(52) U.S. Cl. 714/6; 714/E11.03

(57) ABSTRACT

An information processing apparatus includes: a nonvolatile memory that has a start block for storing a boot program and a spare block for storing a spare of the boot program; and a system controller that reads out the boot program from the start block and executes start-up process in accordance with the boot program, the system controller exclusively performs error correction and detection on the nonvolatile memory, wherein when the boot program is read out from the start block and a read error that cannot be corrected based on an error correction code occurs, the system controller performs recovery process for recovering the start block using the spare of the boot program stored in the spare block.

### CROSS-REFERENCE TO RELATED APPLICATIONS

This application is based upon and claims the benefit of priority from Japanese Patent Application No. 2007-334832, filed on Dec. 26, 2007, the entire content of which are incorporated herein by reference.

### BACKGROUND

1. Field

One embodiment of the present invention relates to an information processing apparatus in which a boot program stored in nonvolatile memory is read out and start-up process is executed.

2. Description of the Related Art

Hitherto, a semiconductor device described in JP-A-2005-215824 (counterpart U.S. publication is: US 2008/046637 A1) has been known as a conventional art in a field related to starting up a computer. In the semiconductor device, a boot program is read from NAND-type flash memory and start-up process is executed. In the NAND-type flash memory of the semiconductor device, the same boot program is stored in a plurality of blocks. If it is determined based on read out of the boot program from one of the blocks, which is defective, the boot program stored in another block is read out. Accordingly, it is made possible to start the device even in a case where a part of memory blocks is defective

However, in order to make it possible to start the device more reliably in the manner of the semiconductor device, it is necessary to store the same boot program in a large number of blocks in advance and thus the initial necessary capacity of the memory becomes undesirably large.

### SUMMARY

According to one aspect of the present invention, there is provided an information processing apparatus including: a nonvolatile memory that has a start block for storing a boot program and a spare block for storing a spare of the boot program; and a system controller that reads out the boot program from the start block and executes start-up process in accordance with the boot program, the system controller exclusively performs error correction and detection on the nonvolatile memory, wherein when the boot program is read out from the start block and a read error that cannot be corrected based on an error correction code occurs, the system controller performs recovery process for recovering the start block using the spare of the boot program stored in the spare block.

### BRIEF DESCRIPTION OF THE SEVERAL VIEWS OF THE DRAWINGS

A general configuration that implements the various feature of the invention will now be described with reference to the drawings. The drawings and the associated descriptions are provided to illustrate embodiments of the invention and not to limit the scope of the invention.

FIG. 1 is a block diagram to show the system configuration of a DVD player as one embodiment of an information processing apparatus according to the invention.

FIG. 2 is a drawing to show an example of the structure of a storage area of NAND flash memory.

FIG. 3 is a flowchart to show an example of start-up process in a DVD player of a first embodiment of the invention.

FIG. 4 is a drawing to show another example of the structure of a storage area of NAND flash memory.

FIG. 5 is a flowchart to show another example of start-up process in the DVD player of the first embodiment of the invention.

FIG. 6 is a flowchart to show an example of start-up process in a DVD player of a second embodiment of the invention.

### DETAILED DESCRIPTION

Embodiments of an information processing apparatus of the invention will be discussed with reference to the accompanying drawings.

### First Embodiment

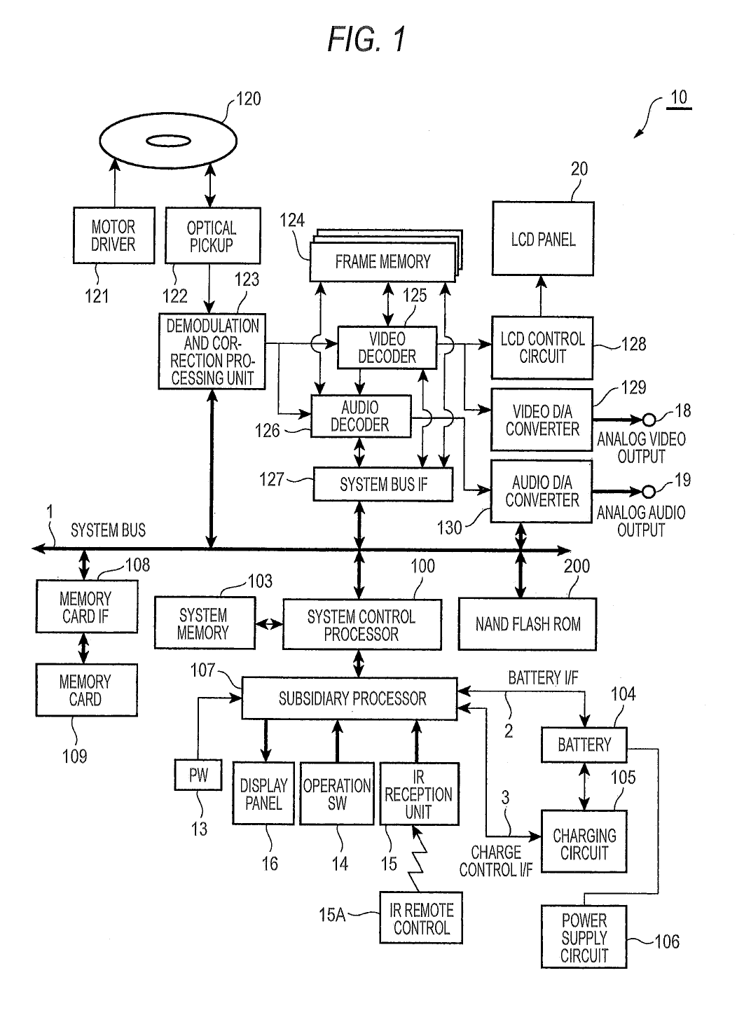

A DVD player 10 will be discussed in detail with reference to the accompanying drawings as a first embodiment of an information processing apparatus according to the invention. As shown in FIG. 1, the DVD player 10 includes a system control processor 100, system memory 103, a battery 104, a charging circuit 105, a power supply circuit 106, a subsidiary processor 107, a memory card interface circuit 108, a motor driver 121, an optical pickup 122, a demodulation and correction processing unit 123, frame memory 124, a video decoder 125, an audio decoder 126, a system bus interface 127, an LCD control circuit 128, a video D/A converter 129, an audio D/A converter 130, and a NAND flash ROM 200.

The system control processor 100 is a processor for controlling the components of the DVD player 10. It reads power consumption information stored in the system memory 103. Further, the system control processor 100 has a function of executing communications with the subsidiary processor 107. The system control processor 100 is connected to a system bus 1.

The subsidiary processor 107 accepts request input from any operation switch 14, an infrared reception unit 15, etc., and reports the accepted request to the system control processor 100. The battery 104 is connected to the subsidiary processor 107 through a battery interface 2. The charging circuit 105 is connected to the subsidiary processor 107 through a charge control interface 3. The subsidiary processor 107 detects the remaining capacity of the battery 104 through the battery interface 2 and reports the detected remaining capacity of the battery 104 to the system control processor 100.

The charging circuit 105 and the power supply circuit 106 are connected to the battery 104. The charging circuit 105 supplies externally supplied power through an AC adapter, etc., connected to the DVD player 10 to the battery 104, thereby charging the battery 104. When the user presses a power button switch 13, the power supply circuit 106 generates the power to be supplied to the components of the DVD player 10 from power of the battery 104. A memory card 109 is connected to the system bus 1 through the memory card interface 108. The memory card 109 functions as a storage device for storing data, etc.

An optical disk drive includes the motor driver 121 and the optical pickup 122. The motor driver 121 rotates a record medium 120. The optical pickup 122 irradiates the record medium 120 with laser light and acquires an AV (audio video) signal from the reflected laser light. The demodulation and correction processing unit 123 performs processing of demodulating the AV signal acquired by the optical pickup 122 and correcting the demodulated AV signal. The demodulation and correction processing unit 123 separates the demodulated and corrected AV signal into dynamic image data and audio data and transmits the dynamic image data to the video decoder 125 and the audio data to the audio decoder 126.

The video decoder 125 decodes the dynamic image data and transmits the decoded dynamic image data to the LCD control circuit 128 and the video digital/analog (D/A) converter 129. The LCD control circuit 128 generates a display signal to display the dynamic image data transmitted from the video decoder 125 on an LCD panel 20. The video digital/analog converter 129 outputs the dynamic image data transmitted from the video decoder 125 to the outside. The audio decoder 126 decodes the audio data and outputs the decoded audio data to the outside or a loudspeaker provided in the DVD player 10 through the audio digital/analog (D/A) converter 130.

The NAND flash ROM (nonvolatile memory) 200 stores a boot program for start-up process of the DVD player 10. When power of the DVD player 10 is turned on, the system control processor 100 loads the boot program from the NAND flash ROM 200 and executes start-up process in accordance with the boot program. It is known that generally the reliability of the NAND-type flash ROM is low, and a read error can occur when the boot program is read from the NAND flash ROM 200. Therefore, error handling assuming such an error needs to be provided so that the DVD player 10 can be started reliably if an error occurs.

The DVD player 10 includes hardware for correcting and detecting an error of the NAND flash ROM 200 only in the system control processor 100. Thus, the system control processor 100 needs to handle a read error by software and ensure the reliability of start as described above. A configuration provided to ensure the reliability of start in the DVD player 10 will be discussed below.

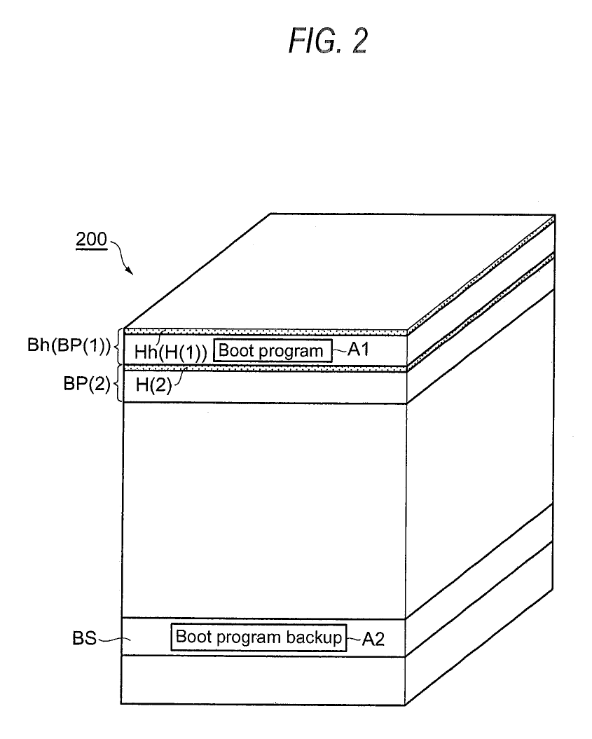

As shown in FIG. 2, the NAND flash ROM 200 has a large number of blocks as a storage area. One block includes a larger number of pages. In the initial NAND flash ROM 200, a top block Bh is reserved as a start block BP and stores a boot program A1. This boot program A1 contains at least a program for performing hardware initialization processing required at the starting time and a program for performing error correction and detection processing of the NAND flash ROM 200. When the DVD player 10 is started, the system control processor 100 (FIG. 1) loads the boot program A1 from the top block Bh and executes start-up process in accordance with the boot program A1.

Further, one spare block BS is reserved initially in the NAND flash ROM 200 and stores a backup of the boot program A1 (which will be hereinafter referred to as “spare-boot program A2”). This spare boot program A2 is identical with the boot program A1 stored in the top block Bh, of course. The NAND flash ROM 200 also stores a system program of product firmware containing an application.

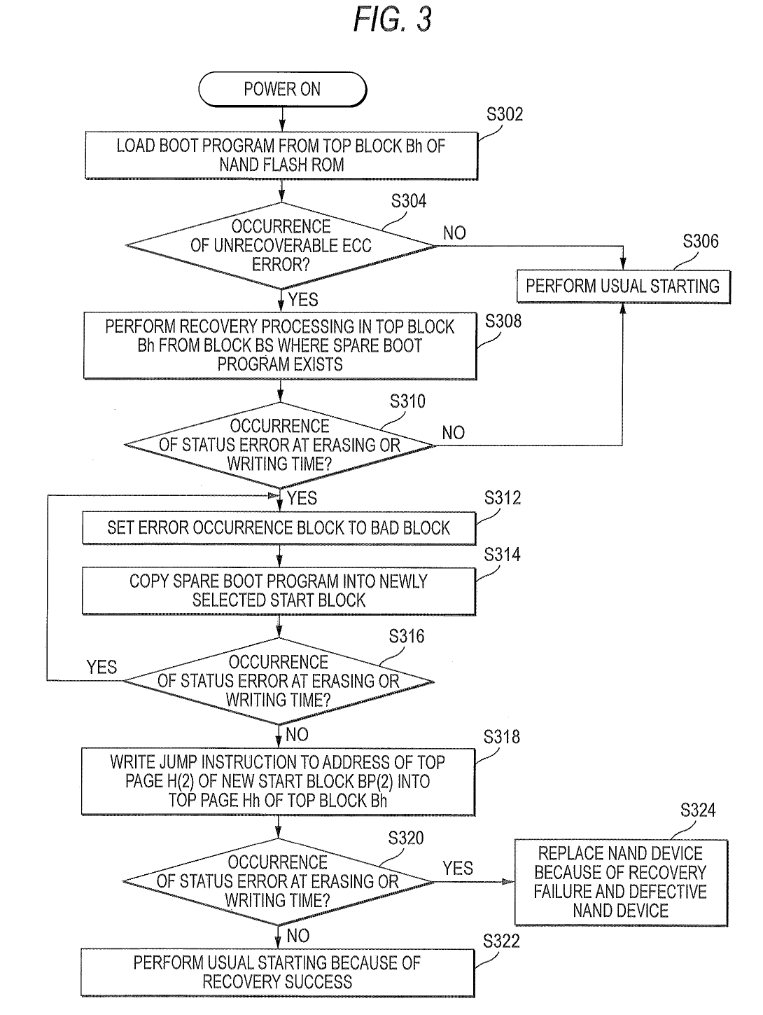

The start-up process of the DVD player 10 at the power on time in the configuration will be discussed with reference to FIGS. 2 and 3. First, when a Power ON event for the system occurs as the power of the DVD player 10 is turned on, reset of the system control processor 100 is released and the system control processor 100 accesses a top page Hh of the top block Bh of the NAND flash ROM 200. The system control processor 100 loads the boot program A1 from the top block Bh (S302).

If the load step S302 is normally complete (NO at S304), the system control processor 100 loads the system program in accordance with the error correction and detection routine of the boot program A1. Then, the system control processor 100 performs usual start-up process according to the loaded system program (S306). The expression “load step S302 is normally complete” at step S304 is used to mean the case where an ECC (Error Correcting Code) error does not occur or the case where the error was recoverable by error correction with the ECC although an ECC error occurred.

Generally, in the NAND-type flash ROM, a read error may occur because of Read Disturb, etc., in operation of only data read and may be unrecoverable if ECC is used. Therefore, an unrecoverable ECC error may occur at the load step S302. Thus, if an unrecoverable ECC error occurs at the load step S302 (YES at S304), recovery processing of the top block Bh is performed using the spare boot program A2 stored in the spare block BS (S308). That is, the boot program A1 in the top block Bh is once erased and a copy of the spare boot program A2 is written into the top block Bh, whereby the top block Bh is recovered from the error.

If a normal erasing and write result in success at the recovery step S308 (YES at S310), then the system program is loaded and usual start-up process is performed (S306). On the other hand, it is also possible that an error will occur at the recovery step S308. Thus, if a status error at the erasing or writing time occurs at the recovery step S308 (YES at 310), the system control processor 100 marks the top block Bh a bad block (defective block) (S312).

The system control processor 100 selects a block to be adopted as a new start block (for example, selects an empty block next to the top block Bh) and copies the spare boot program A2 in the spare block BS into the selected block (S314). If a status error at the erasing or writing time occurs at step S314 (YES at S316), steps S312 and S314 are repeated until a block where no error occurs is selected. Thus, a new start block BP (2) storing the boot program A1 is created.

Subsequently, a jump instruction to the address of a top page H(2) of the new start block BP(2) is written into the top page Hh of the top block Bh assumed to be a defective block (S318). If the writing at step S318 is normally completed (YES at S320), the recovery processing results in success. Accordingly, the system program is loaded and usual start-up process is performed (S322). On the other hand, if a status error at the erasing or writing time occurs at step S318 (YES at S320), the recovery processing results in failure and the NAND flash ROM 200 needs to be replaced with a normal product (S324).

In the DVD player 10 after execution of steps S312 to S322 described above, at the next starting time, first the system control processor 100 accesses the top page Hh of the top block Bh of the NAND flash ROM 200 and jumps to the top page H(2) of the old start block BP(2) in accordance with a jump instruction described in the top page Hh. Then, the system control processor 100 loads the boot program A1 stored in the start block BP(2).

As described above, in the DVD player 10, if the current start block BP (initially, the top block Bh) is defective at the starting time, the start block BP is marked a bad block and a new start block BP is created and is adopted in place of the defective start block. Therefore, if putting the start block into a bad block and creating a new start block are repeated with an extended period of use of the DVD player 10, the NAND flash ROM 200 enters a state in which bad blocks BP(1) to BP(n−1) that cannot be used and one start block BP(n) that can be used are contained. Here, the block adopted at the j-th time, of the successive start blocks BP of the NAND flash ROM 200 is represented as “start block BP (j)” and the top page of the start block BP(j) is represented as “top page H(j)” (j=1, 2, 3, . . . ).

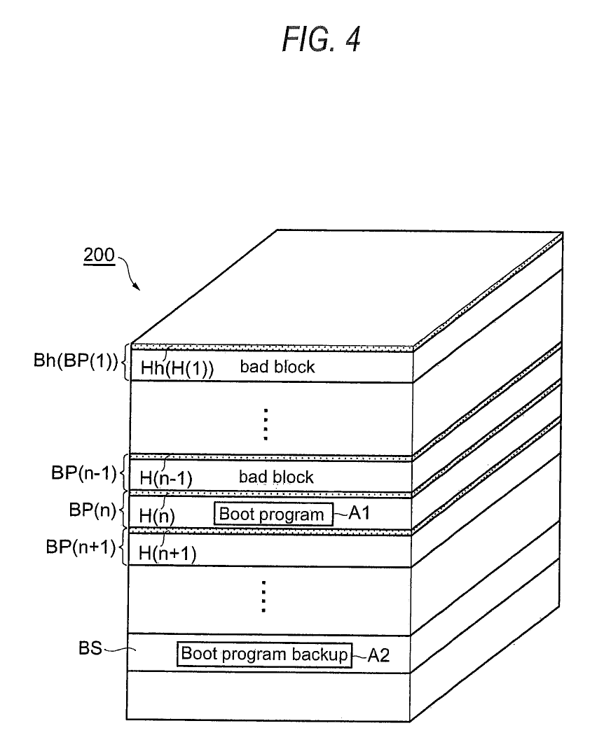

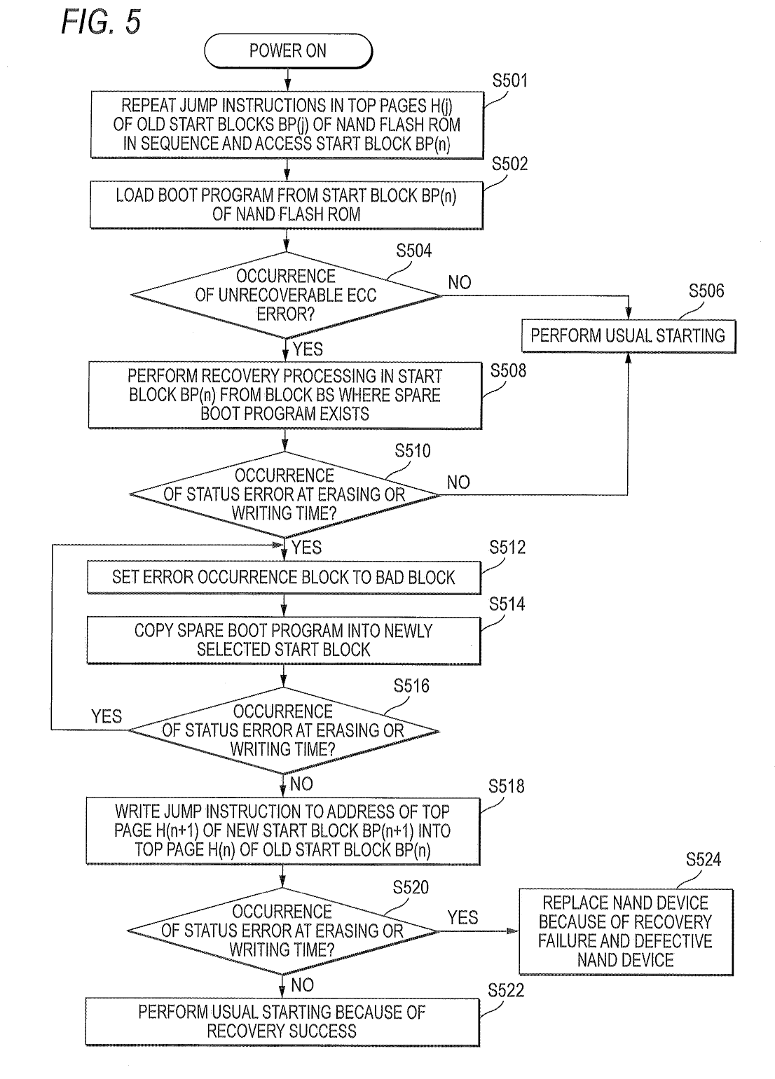

Start-up process of the DVD player 10 in a state in which the start block BP (n) is used at present will be discussed below with reference to FIGS. 4 and 5. To begin with, when a Power ON event for the system occurs as the power of the DVD player 10 is turned on, reset of the system control processor 100 is released and the system control processor 100 accesses the top page Hh of the top block Bh of the NAND flash ROM 200. The system control processor 100 accesses the top page H(n) of the start block BP(n) through the jump instruction described in the top page Hh and the jump instruction in the top page H(j) of each old start block BP(j) assumed to be a bad block (S501) and loads the boot program A1 from the start block BP(n) (S502).

If the load step S502 is normally completed (NO at S504), the system control processor 100 loads the system program in accordance with the error correction and detection routine of the boot program A1. Then, the system control processor 100 performs usual start-up process according to the loaded system program (S506). The expression “load step S502 is normally complete” at step S504 is used to mean the case where an ECC error does not occur or the case where the error was recoverable by error correction with the ECC although an ECC error occurred. Generally, in the NAND-type flash ROM, a read error may occur because of Read Disturb, etc., in operation of only data read and may be unrecoverable if ECC is used. Therefore, an unrecoverable ECC error may occur at the load step S502. Thus, if an unrecoverable ECC error occurs at the load step S502 (YES at S504), recovery processing of the start block BP(n) is performed using the spare boot program A2 stored in the spare block BS (S508). That is, the boot program A1 in the start block BP(n) is once erased and a copy of the spare boot program A2 is written into the start block BP (n), whereby the start block BP(n) is recovered from the error.

If normal erasing and write result in success at the recovery step S508 (YES at S510), then the system program is loaded and usual start-up process is performed (S506).

On the other hand, it is also possible that an error will occur at the recovery step S508. Thus, if a status error at the erasing or writing time occurs at the recovery step S508 (YES at 510), the system control processor 100 marks the current start block BP(n) a bad block (S512).

The system control processor 100 selects a block to be adopted as a new start block (for example, selects an empty block next to the start block BP (n)) and copies the spare boot program A2 in the spare block BS into the selected block (S514). If a status error at the erasing or writing time occurs in the copy at step S514 (YES at S516), steps S512 and S514 are repeated until a block where no error occurs is selected. Thus, a new start block BP (n+1) storing the boot program A1 is created.

Subsequently, a jump instruction to the address of a top page H(n+1) of the new start block BP(n+1) is written into the top page H(n) of the old start block BP(n) assumed to be a defective block (S518). If the writing at step S518 is normally completed (YES at S520), the recovery processing results in success. Accordingly, the system program is loaded and usual start-up process is performed (S522). On the other hand, if a status error at the erasing or writing time occurs at step S518 (YES at S520), the recovery processing results in failure and the NAND flash ROM 200 needs to be replaced with a normal product (S524).

In the DVD player 10 after execution of steps S512 to S522 described above, at the next starting time, first the system control processor 100 accesses the top page Hh of the top block Bh of the NAND flash ROM 200 and jumps to the top page H(2) of the old start block BP(2) in accordance with the jump instruction described in the top page Hh. Then, the system control processor 100 jumps to the top page H(3) of the old start block BP(3) in accordance with the jump instruction described in the top page H(2). Likewise, the system control processor 100 repeats the jump instructions described in the top pages H(j) of the successive old start blocks BP (S501) and finally loads the boot program A1 stored in the most recent start block BP(n+1) (S502).

As described above, in the initial DVD player 10, the top block Bh is set to the start block. Therefore, the start-up process of the initial DVD player 10 previously described with FIG. 3 can be explained as start-up process in which n=1 and the top block Bh is set to the start block BP(1) in FIG. 5.

According to the structure of the NAND flash ROM 200 and the start-up process as described above, if an unrecoverable ECC error occurs at the load step S302 or S502 of the boot program A1 from the start block BP (n), recovery processing of the start block BP(n) (S308, S508) is performed using the spare boot program A2 stored in the spare block BS. Consequently, the reliability of start of the DVD player 10 can be ensured.

An attempt is made to perform recovery processing from the spare block BS without immediately assuming the start block BP (n) where a read error occurred to be a defective block, so that an increase in the number of defective blocks is suppressed and waste of the memory capacity is further lessened.

If an erase error or a write error occurs in the recovery processing (S308, S508), the start block BP(n) is marked a bad block and a new start block BP(n+1) can be created. Therefore, if the recovery processing of the start block BP(n) (S308, S508) is impossible, the next start block BP(n+1) is created, whereby the reliability of start of the DVD player 10 can be ensured. That is, according to the structure of the NAND flash ROM 200 and the start-up process, unless an error occurs in the first page of the start block BP (S320-S324, S520-S524), start failure and fault of the NAND flash ROM 200 do not occur. Consequently, the occurrence probability of start fault of the DVD player 10 caused by fault of the NAND flash ROM 200 can be decreased and the reliability of start of the DVD player 10 can be ensured.

Initially, a start block BP and a spare block BS may be provided in the NAND flash ROM 200, so that initially a large number of blocks need not be reserved for backup blocks and waste of the memory capacity is further lessened. The manufacturing cost of the DVD player 10 can be decreased because the reliability of start of the DVD player 10 is ensured without including hardware for correcting and detecting an error of the NAND flash ROM 200.

### Second Embodiment

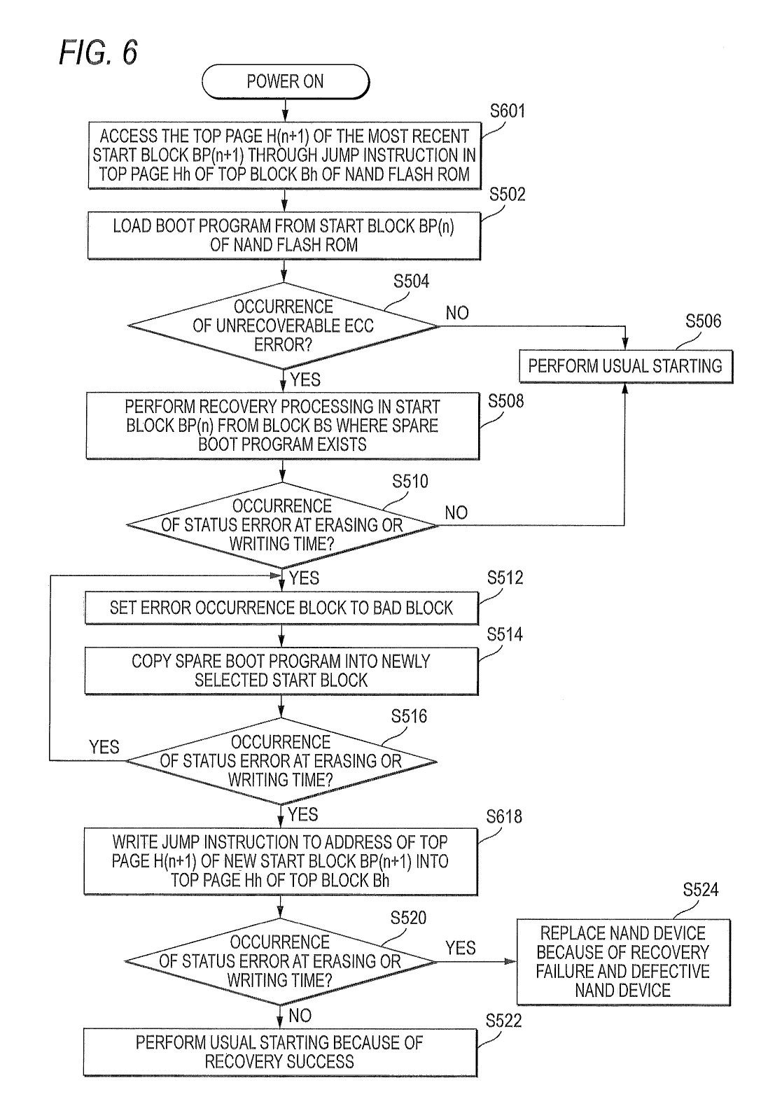

In a second embodiment described herein, processing of writing a jump instruction to a top page H (n+1) of a new start block BP(n+1) into a top page Hh of a top block Bh (S618) is performed instead of step S518 (FIG. 5) in the first embodiment described above. In a DVD player after execution of such processing, at the next starting time, first a system control processor 100 accesses the top page Hh of the top block Bh of NAND flash ROM 200 and accesses the top page H(n+1) of the most recent start block BP(n+1) in accordance with the jump instruction described in the top page Hh (S601). Then, the system control processor 100 loads a boot program A1 stored in the most recent start block BP(n+1) (S502). Steps identical with or similar to those in the first embodiment are denoted by the same step numbers in FIG. 6 in the second embodiment and will not be discussed again.

According to the DVD player and the start method of the second embodiment, advantages similar to those of the DVD player 10 and the start method of the first embodiment described above can be provided and more than one jump processing at step S501 (FIG. 5) can be skipped. However, in the DVD player and the start method of the second embodiment, as the top page Hh of the top block Bh is rewritten each time, the probability that an error at the rewriting time will occur increases. In contrast, the DVD player 10 and the start method of the first embodiment described above are excellent in that such a problem is hard to occur.

It is to be understood that the invention is not limited to the above-described specific embodiments thereof. For example, in the above-described embodiments, the invention is applied to the DVD player, but can be applied to various information processing apparatus, such as a DVD recorder, a mobile telephone, a music player, and a music player capable of playing back video.

What is claimed is:

1. An information processing apparatus comprising:
a nonvolatile memory that has a start block for storing a boot program and a spare block for storing a spare of the boot program; and
a system controller that reads out the boot program from the start block and executes start-up process in accordance with the boot program, the system controller exclusively performs error correction and detection on the nonvolatile memory,
wherein when the boot program is read out from the start block and a read error that cannot be corrected based on an error correction code occurs, the system controller performs recovery process for recovering the start block using the spare of the boot program stored in the spare block.

2. The apparatus according to claim 1, wherein when a write error or an erase error of the start block occurs in the recovery process, the system controller operates to:
assume that the start block of the nonvolatile memory is a defective block;
select a new start block other than the start block or the spare block;
copy the spare boot program into the new start block; and
write a jump instruction to jump to the top page of the new start block into the top page of the start block that is assumed to be the defective block.

3. The apparatus according to claim 1, wherein when a write error or an erase error of the start block occurs in the recovery process, the system controller operate to:
assume that the start block of the nonvolatile memory is a defective block;
select a new start block other than the start block or the spare block;
copy the spare boot program into the new start block; and
write a jump instruction to jump to the top page of the new start block into the top page of the top block of the nonvolatile memory.

4. The apparatus according to claim 1, wherein the boot program contains instruction for an initialization process to initialize hardware and an error correction and detection process for performing error correction and error detection on the nonvolatile memory.
